(19) United States
(12) Patent Application Publication
(10) Pub. No.: US 2019/0346016 A1
(43) Pub. Date: Nov. 14, 2019

(54) A TRANSVERSE SEGMENT FOR A DRIVE BELT FOR A CONTINUOUSLY VARIABLE TRANSMISSION

(71) Applicant: ROBERT BOSCH GMBH, Stuttgart (DE)

(72) Inventors: Adrianus Antonius Jacobus Maria VAN TREIJEN, Breda (NL); Joost Johannes Cornelis JONKERS, Gilze (NL); Guillaume Gerard Hubertus ROMPEN, Munstergeleen (NL); Peter BROUWERS, Tilburg (NL)

(21) Appl. No.: 16/473,106

(22) PCT Filed: Jan. 2, 2018
(86) PCT No.: PCT/EP2018/025001

§ 371 Date: Jun. 24, 2019

(30) Foreign Application Priority Data
Dec. 30, 2016 (NL) 1042203

(51) Int. Cl. F16G 5/16

(52) U.S. Cl. CPC F16G 5/16

(57) ABSTRACT

Disclosed is a transverse segment for a drive belt with a ring stack and with a number of transverse segments attached along the circumference of the ring stack, which transverse segment at least includes a base portion and two pillar portions, which pillar portions extend from the sides of the base portion in height direction, between which pillar portion an upper side of the base portion defines a support surface for supporting the ring stack. At least one pillar portion is provided with a hook part that extends in width direction in the general direction of the respective other pillar portion and whereof a bottom surface that is oriented in the general direction of the support surface extends at an angle relative to the width direction.

This disclosure relates to a transverse segment that is destined to be part of a drive belt for a continuously variable transmission with two pulleys and the drive belt. Such a drive belt is commonly known and is mainly applied running around and between the two transmission pulleys, which pulleys each define a V-groove of variable width wherein a respective circumference part of the drive belt is held.

A known type of drive belt comprises an essentially contiguous row of transverse segments that are mounted on and around the circumference of a number of endless bands or rings that are mutually stacked in the radial direction. Each such transverse segment defines a central opening that is open towards the radial outside of the drive belt and that accommodates and confines a respective circumference section of such ring stack, while allowing the transverse segments to move along the circumference thereof. This particular type of drive belt is for example known from the European patent publication No. EP-1219860-A1.

In the above and the below description, the axial, radial and circumference directions are defined relative to the drive belt when placed in a circular posture. Furthermore, a thickness dimension of the transverse segments is defined in the circumference direction of the push belt, a height dimension of the transverse segment is defined in the said radial direction and a width dimension of the transverse segment is defined in the said axial direction.

The known transverse segment comprises a base portion and two pillar portions that extend from the base portion at either axial side thereof in radial outward direction, i.e. upwards in height direction. The said central opening accommodating the ring stack is defined by and between the base portion and the two pillar portions. In between the pillar portions the said opening is bound by a radially outward facing, support surface of the base portion defines that supports the ring stack from the radial inside thereof. Both pillar portions of the known belt are provided with a hook part extending in axial direction over the central opening that is thereby partly closed in radial outward direction as well. A bottom, i.e. radially inner surface of each hook part thus engages the ring stack from the radial outside thereof, whereby the latter is contained it inside the central opening of the transverse segment. It is also known in the art to provide only one of the pillar portions with the hook part, as described in, for example, the Japanese patent publication JP-S58-109748.

According to the present disclosure, the known design of the transverse segment can still be improved upon, in particular in terms of, surprisingly, the service life of the ring stack. During operation, the ring stack is not only stressed by tension and bending forces, but also by the contact with the transverse segments. Such contact stress in the ring stack does not only occur at the radially inner side of the ring stack by the contact with the carrying surfaces of the transverse segments, but also at its radial outer side by the contact with the hook parts of the transverse segments. The force level associated with this latter contact was previously considered insignificant, in particular in comparison with the force exerted by/through the carrying surface on the ring stack. However, according the present disclosure, even at such relatively low force level, some small damage, e.g. scratching, of the outer surface of the ring stack occurs. Even though a resulting surface defect will not noticeably influence the tensile strength of the outermost ring of the ring stack, it can compromise the ultimate fatigue strength thereof.

According to the present disclosure, the said contact between the bottom surface of the hook part or hook parts of the transverse segment and the outer surface of the ring stack can be favourably mitigated by partly orienting the said axially extending bottom surface of the hook part(s) also in radially outward direction as seen in a direction form the respective pillar portion towards the axial centre of the recess, i.e. towards the respective other pillar portion. By this feature it is taken into account that in practice the ring stack shows a convex curvature in its width, i.e. in its axial direction, at least in a straight trajectory part of the drive belt in the transmission where the said contact with the hook part occurs. Preferably, the said bottom surface is oriented at an angle relative to the axial direction and/or relative to the plane of the support surface, which angle has value in the range between 2 and 10 degrees, more preferably in the range between 4 and 8 degrees.

According to the present disclosure, the said bottom surface can for example be oriented at an angle α relative to the axial direction according to the equation:

α≈arcsine(1/2 W/Rars) (1)
with W representing the width, i.e. the axial dimension of the ring stack and Rars representing a radius of curvature in axial direction of the ring stack in a straight trajectory part of the drive belt in the transmission.

It is noted, however, the said angle α is preferably chosen somewhat larger than the value that is calculated with equation (1), e.g. by a factor of 2, in order to facilitate assembly of the drive belt, i.e. in order to facilitate the mounting of the transverse segments on the ring stack. It is further noted that the said bottom surface need not necessarily be a flat plane. It can also be concavely or convexly curved, as long as it satisfies one or more of the relevant criteria mentioned hereinabove. Preferably in this latter respect, the said bottom surface describes a concave arc having a radius corresponding to the above radius Rars.

The above novel transverse segment design according to the present disclosure will now be explained further with reference to the drawing, in which:

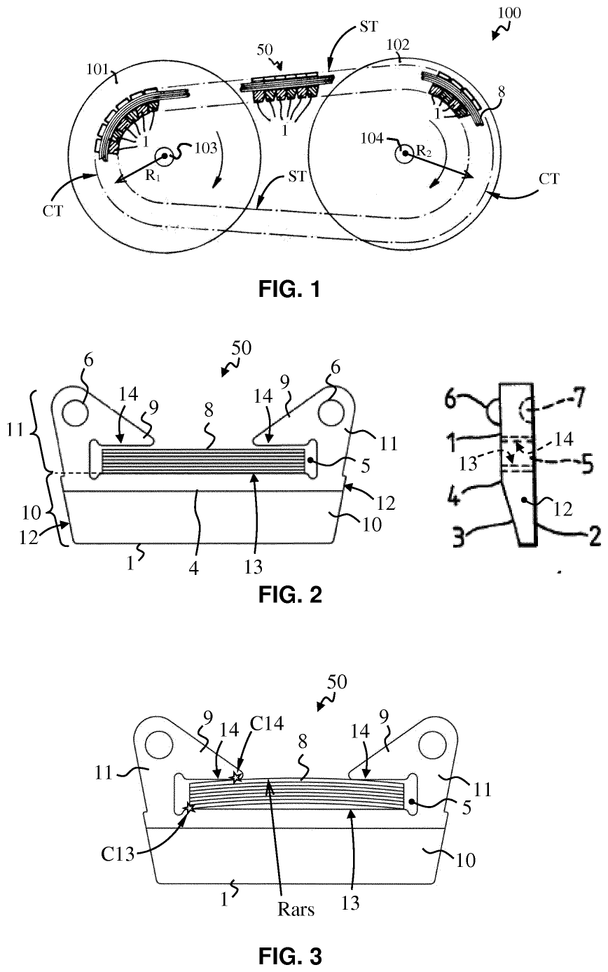

FIG. 1 is a simplified and schematic side elevation of a transmission with two pulleys and a drive belt;

FIG. 2 schematically illustrates the known drive belt with generally V-shaped transverse segments in a cross-section thereof facing in its circumference direction and also includes a separate side elevation of only the transverse segment thereof;

FIG. 3 schematically illustrates the known drive belt in a cross-section in a straight trajectory part thereof between the two pulleys;

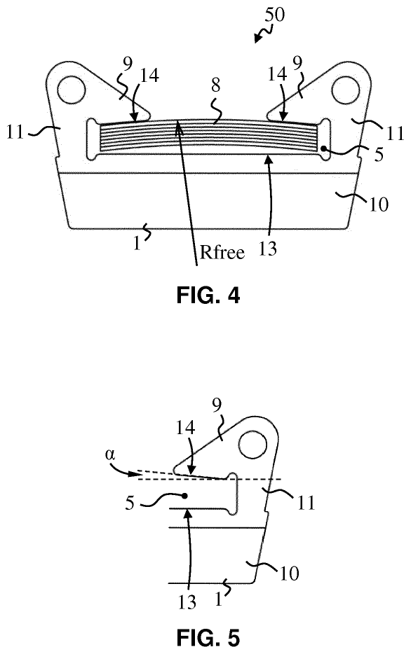

FIG. 4 schematically illustrates the novel drive belt according to the present disclosure in a cross-section in a straight trajectory part thereof between the two pulleys; and

FIG. 5 provides a detail of the transverse segment of the novel drive belt of FIG. 4.

FIG. 1 schematically shows the central parts of a continuously variable transmission 100 for use in a driveline of, for example, passenger motor vehicles. This transmission 100 is well-known per se and comprises at least a first variable pulley 101 and a second variable pulley 102. In the driveline, the first pulley 101 is coupled to a drive motor, i.e. engine and the second pulley 102 is typically coupled to driven wheels of the motor vehicle via a number of gears.

Both transmission pulleys 101, 102 comprise a first conical pulley sheave that is fixed to a pulley shaft 103, 104 of the respective pulley 101, 102 and a second conical pulley sheave that is axially displaceable relative to the respective pulley shaft 103, 104 and that is fixed thereto only in rotational direction. A drive belt 50 of the transmission 100 is wrapped around the pulleys 101, 102, while being accommodated between the pulley sheaves thereof. As appears from FIG. 1, the trajectory of the drive belt 50 in the transmission 100 includes two straight parts ST and two curved parts CT where the drive belt 50 is curved around a respective one of the two transmission pulleys 101, 102.

The known drive belt 50 is composed of an ring stack 8 and a plurality of transverse segments 1 that are mounted on the ring stack 8 along the circumference thereof in an, at least essentially, contiguous row. For the sake of simplicity, only a few of these transverse segments 10 are shown in FIG. 1.

In the drive belt 50 the transverse segments 1 are movable along the circumference of the ring stack 8, which ring stack 8 is typically composed of a number of flexible metal bands, which metal bands are stacked one around one another, i.e. are mutually nested. During operation of the transmission 100, the transverse segments 1 of the drive belt 50 at the driven pulley 101 are driven in the direction of rotation thereof by friction. These driven transverse segments 1 push preceding transverse segments 1 along the circumference of the ring stack 8 of the drive belt 50 and, ultimately, rotationally drive the driving pulley 102, again by friction. In order to generate such friction (force) between the transverse segments 1 and the transmission pulleys 101, 102, the said pulley sheaves of each pulley 101, 102 are forced towards one another in axial direction, whereby these exert a pinching force on the transverse segments 1 in the axial direction thereof. To this end, electronically controllable and hydraulically acting movement means that act on the respective moveable pulley sheave of each pulley 101, 102 are provided in the transmission 100 (not shown). In addition to exerting a pinching force on the drive belt 50, these movement means also control respective radial positions R1 and R2 of the drive belt 50 at the pulleys 101, 102 and, hence, the speed ratio that is provided by the transmission 100 between the pulley shafts 103, 104 thereof.

In FIG. 2 the known drive belt 50 is schematically illustrated. On the left side of FIG. 2 the drive belt 50 is shown in cross-section and on the right side of FIG. 2 a side elevation of only the transverse segment 1 thereof is included. From FIG. 2 it appears that the transverse segments 1 of the drive belt 50 are generally shaped similar to the letter “V”, i.e. are generally V-shaped. In other words, side faces 12 of the transverse segments 1 through which it arrives in (friction) contact with the transmission pulleys 101, 102, are mutually oriented at an angle that closely matches an angle that is present between the conical pulley sheaves of the transmission pulleys 101, 102. These pulley contact faces 12 are either corrugated by a macroscopic profile or are provided with a rough surface structure, such that only the higher lying peaks of the corrugation profile or of the surface roughness arrive in contact with the transmission pulleys 101, 102. This particular feature of the transverse segment design provides that the friction between the drive belt 50 and the transmission pulleys 101, 102 is optimized by allowing cooling oil that is applied in the known transmission 100 to be accommodated in the lower lying parts of the corrugation profile or of the surface roughness.

Each transverse segment 1 defines a base portion 10 and two pillar portions 11, whereof the base portion 10 extends mainly in the axial direction of the drive belt 50 and whereof the pillar portions 11 extend mainly in the radial direction of the drive belt 50, each from a respective axial sides of the base portion 10. In its thickness direction, each transverse segments 1 extends between a front surface 3 and a rear surface 2 thereof that are both oriented, at least generally, in the circumference direction of the drive belt 50. An opening 5 is defined between the pillar portions 11 and the base portion 10 of each transverse segment, wherein a circumference section of the ring stack 8 is accommodated. A radially outward facing part 13 of the circumference surface of the base portion, forming the radially inner boundary of the opening, supports the ring stack 8 from the radial inside, which surface part is denoted support surface 13 hereinafter.

In the row of transverse segments 1 of the drive belt 50, at least a part of a front main body surface 3 of the transverse segment 1 abuts against at least a part of the rear main body surface 2 of a respectively preceding transverse segment 1 in the said row, whereas at least a part of the rear main body surface 2 of the transverse segment 1 abuts against at least a part of the front main body surface 3 of a respectively succeeding transverse segment 1. The abutting transverse segments 1 are able to tilt relative to one another, while remaining in mutual contact at and through an axially extending and radially, convexly curved surface part 4 of the front surfaces 3 thereof, which surface part is denoted tilting edge 4 hereinafter. In FIG. 2, the tilting edge 4 is located in the base portion 10 of the transverse segment 1. It is also known to locate the tilting edge 4 in the pillar portions 11, i.e. in two separate, however mutually axially aligned, sections (not shown).

The pillar portions 11 of the transverse segments 1 are each provided with a projection 6 that protrudes from the respective front surface 3 in, essentially, the said circumference direction. In the drive belt 50, the projection 6 is inserted in a recess 7 provided in the opposite, i.e. rear surface 2 of an adjacent transverse segment 1 to limit a relative movement between the adjacent transverse segments 1, at least in radial direction, but typically also in axial direction.

The pillar portions 11 of the transverse segments 1 are each further provided with a hook part 9 extending in axial direction over the opening 5 that is thereby partly closed in radial outward direction by a bottom, i.e. radially inner surface 14 of each hook part 9. The hook parts 9 prevent that the transverse segments 1 can separate from the ring stack 8 in radial inward direction.

In FIG. 2 the drive belt 50 is illustrated with the ring stack 8 thereof in contact with the support surface 13 of the transverse segment(s) 1 thereof. However, in practice it also occurs, in particular in the straight trajectory parts ST of the drive belt 50 in the transmission, that the transverse segments 1 move in radial inward direction relative to the ring stack 8. In this case, the ring stack 8 arrives in contact with the bottom surfaces 14 of the hook parts 9 of the pillar portions 11 thereof engage the axial sides of the ring stack 8, as indicated in FIG. 3 in a cross-section of the drive belt 50 in the said straight trajectory part ST.

In the cross-section in the straight trajectory part ST of the known drive belt 50 of FIG. 3, the ring stack 8 is shown to be curved in axial direction such that the radially outer side thereof is convexly curved. Such a transverse curvature or crowning radius is typically provided to the ring stack 8, i.e. to each individual ring thereof, in the manufacturing process thereof. By this crowning radius in particular the maximum bending stress occurring in the ring stack 8 during operation can be reduced, at least relative to a ring stack 8 that is assembled from flat rings. This design feature of the rings of the ring stack 8 is discussed in the European patent No. EP-1111271-B1.

As a result of its transverse curvature, the ring stack 8 arrives in contact with the bottom surfaces 14 of the hook parts 9 of the pillar portions 11 of the transverse segment 1 towards its axial sides, in particular at the location of the ultimate axial edge C14 of the hook part 9, as indicated in FIG. 3. According to the present disclosure, such point contact can be detrimental to the performance of the drive belt 50 in that the outer surface of the ring stack 8 can locally be damaged and/or worn thereby. In particular if, as schematically illustrated in FIG. 3, a radius Rars of convex curvature that is allowed by the design of the transverse segment 1 is smaller than a free state crowning radius Rfree of the ring stack 8 that would be measured in a straightened section thereof outside the drive belt 50, i.e. without the said convex curvature thereof being limited by the interaction with the transverse segments 1. Namely, the ring stack 8 is in this latter case not only in point contact with the said bottom surfaces 14, but also still with the said support surface 13, e.g. at point C13 in FIG. 3, and is clamped there between in radial direction.

In order to mitigate the contact between the ring stack 8 and the transverse segment 1 in the straight trajectory part ST of the drive belt 50, the axially extending bottom surface 14 of the hook part 9 or of the hook parts 9 of the transverse segment is angled radially outward, as schematically illustrated in FIG. 4. In particular, the said bottom surface 14 is oriented not only in axial direction, but also in radially outward direction as seen in a direction away from the respective pillar portion 11 towards an axial centre of the opening 5, i.e. towards the opposite pillar portion 11. In FIG. 5, the novel transverse segment 1 is shown in somewhat more detail to illustrate the angle α between the said axial direction and the bottom surface 14 of the hook part 9 of the pillar portion 11 thereof. In a practical design of the transverse segment 1 according to the present disclosure, such angle α amounts to approximately 6 degrees for example. By such design of the said bottom surface 14, the contact with the ring stack 8 is moved away from a relatively sharply curved axial of the hook part 9 towards a more centrally located flat part thereof. Hereby, a contact stress between the transverse segment 1 and the ring stack 8 can be favourably reduced.

Further in FIG. 4 a preferred feature according to the present disclosure is illustrated, namely that a clearance in radial direction between the support surface 13 and the bottom surfaces 14 of the hook parts 9 is defined to allow the ring stack 8 to convexly curve at its natural, i.e. free state crowning radius Rfree. Hereby, a radial force exchanged between the ring stack 8 and the hook parts 9 of the transverse segment 1 in the said contact there between is favourably reduced to a minimum.

The present disclosure, in addition to the entirety of the preceding description and all details of the accompanying figures, also concerns and includes all the features of the appended set of claims. Bracketed references in the claims do not limit the scope thereof, but are merely provided as non-binding examples of the respective features. The claimed features can be applied separately in a given product or a given process, as the case may be, but it is also possible to apply any combination of two or more of such features therein.

The invention(s) represented by the present disclosure is (are) not limited to the embodiments and/or the examples that are explicitly mentioned herein, but also encompasses amendments, modifications and practical applications thereof, in particular those that lie within reach of the person skilled in the relevant art.

1-7. (canceled)

8. A drive belt (50) with a ring stack (8), which ring stack (8) is composed of a number of stacked endless rings and is convexly curved in width direction in a straight part (ST) of the circumference of the drive belt (50), and with a number of transverse segments (1) arranged along the circumference of the ring stack (8), which transverse segments (1) each comprises at least a base portion (10) and two pillar portions (11), which pillar portions (11) extend in height direction on either side of the transverse segment (1) from the base portion (10) and where between a top side of the base portion (10) provides in a support surface (13) for supporting the ring stack (8), at least one of which pillar portions (11) comprises a hook part (9) that extends width-wise in the direction of the respectively other pillar portion (11), wherein, a bottom surface (14) of the hook part (9) facing the support surface (13) of the base portion (10) is oriented at an angle α relative to the plane of the support surface (13) amounting to between 2 and 10 degrees.

9. The drive belt (50) according to claim 8, wherein, the said angle α amounts to between 4 and 8 degrees.

10. The drive belt (50) according to claim 8, wherein, the bottom surface (14) of the hook part (9) is an at least predominantly flat surface.

11. The drive belt (50) according to claim 8, wherein, the bottom surface (14) of the hook part (9) is convexly curved.

12. The drive belt (50) according to claim 8, wherein, the bottom surface (14) of the hook part (9) is concavely curved.

13. The drive belt (50) according to claim 8, wherein in the said straight part (ST) of the circumference of the drive belt (50), the ring stack (8) is convexly curved in width direction according to a radius of curvature Rars and wherein the said angle α at which the bottom surface (14) of the hook part (9) is oriented relative to the width direction satisfies the equation:
α≥arcsinus(1/2 W/Rars),
with W representing the width of the ring stack (8).

14. The drive belt (50) according to claim 13, wherein, a distance in height direction between the support surface (13) of the base portion and the bottom surface (14) of the hook part (9) of the transverse segments (1) thereof is larger than a dimension in height direction of the ring stack (8), which dimension is determined by the nominal thickness of the ring stack (8) in combination with the said curvature thereof in width direction.

15. The drive belt (50) according to claim 9, wherein, the bottom surface (14) of the hook part (9) is an at least predominantly flat surface.

16. The drive belt (50) according to claim 9, wherein, the bottom surface (14) of the hook part (9) is convexly curved.

17. The drive belt (50) according to claim 9, wherein, the bottom surface (14) of the hook part (9) is concavely curved.

18. The drive belt (50) according to claim 9, wherein in the said straight part (ST) of the circumference of the drive belt (50), the ring stack (8) is convexly curved in width direction according to a radius of curvature Rars and wherein the said angle α at which the bottom surface (14) of the hook part (9) is oriented relative to the width direction satisfies the equation:
α≥arcsinus(1/2 W/Rars),
with W representing the width of the ring stack (8).

19. The drive belt (50) according to claim 10, wherein in the said straight part (ST) of the circumference of the drive belt (50), the ring stack (8) is convexly curved in width direction according to a radius of curvature Rars and wherein the said angle α at which the bottom surface (14) of the hook part (9) is oriented relative to the width direction satisfies the equation:
α≥arcsinus(1/2 W/Rars),
with W representing the width of the ring stack (8).

20. The drive belt (50) according to claim 11, wherein in the said straight part (ST) of the circumference of the drive belt (50), the ring stack (8) is convexly curved in width direction according to a radius of curvature Rars and wherein the said angle α at which the bottom surface (14) of the hook part (9) is oriented relative to the width direction satisfies the equation:
α≥arcsinus(1/2 W/Rars),
with W representing the width of the ring stack (8).

21. The drive belt (50) according to claim 12, wherein in the said straight part (ST) of the circumference of the drive belt (50), the ring stack (8) is convexly curved in width direction according to a radius of curvature Rars and wherein the said angle α at which the bottom surface (14) of the hook part (9) is oriented relative to the width direction satisfies the equation:
α≥arcsinus(1/2 W/Rars),
with W representing the width of the ring stack (8).

22. The drive belt (50) according to claim 15, wherein in the said straight part (ST) of the circumference of the drive belt (50), the ring stack (8) is convexly curved in width direction according to a radius of curvature Rars and wherein the said angle α at which the bottom surface (14) of the hook part (9) is oriented relative to the width direction satisfies the equation:
α≥arcsinus(1/2 W/Rars),
with W representing the width of the ring stack (8).

23. The drive belt (50) according to claim 16, wherein in the said straight part (ST) of the circumference of the drive belt (50), the ring stack (8) is convexly curved in width direction according to a radius of curvature Rars and wherein the said angle α at which the bottom surface (14) of the hook part (9) is oriented relative to the width direction satisfies the equation:
α≥arcsinus(1/2 W/Rars),
with W representing the width of the ring stack (8).

24. The drive belt (50) according to claim 17, wherein in the said straight part (ST) of the circumference of the drive belt (50), the ring stack (8) is convexly curved in width direction according to a radius of curvature Rars and wherein the said angle α at which the bottom surface (14) of the hook part (9) is oriented relative to the width direction satisfies the equation:
α≥arcsinus(1/2 W/Rars),
with W representing the width of the ring stack (8).
